(19) United States
(12) Patent Application Publication
(10) Pub. No.: US 2021/0176438 A1
(43) Pub. Date: Jun. 10, 2021

(54) RETINAL DISPLAY APPARATUS AND METHOD

(71) Applicant: Huawei Technologies Co., Ltd., Shenzhen (CN)

(72) Inventors: Hector NAVARRO FRUCTUOSO, Munich (DE); Panji SETIAWAN, Munich (DE)

(21) Appl. No.: 17/154,843

(22) Filed: Jan. 21, 2021

Related U.S. Application Data
(63) Continuation of application No. PCT/EP2018/070863, filed on Aug. 1, 2018.

(51) Int. Cl. H04N 9/31; G06F 3/01; G02B 27/00; G02B 27/09

(52) U.S. Cl. CPC H04N 9/317; G02B 27/0955; G02B 27/0093; G06F 3/013

(57) ABSTRACT

A retinal display apparatus for generating an image on the retina of an eye of a user is provided. The retinal display apparatus generates an output beam conveying the image and directs the output beam toward the pupil of an eye of a user. The apparatus comprises an eye-tracking device and steers the output beam in accordance with a current orientation of the eye.

### CROSS-REFERENCE TO RELATED APPLICATIONS

This application is a continuation of International Application No. PCT/EP2018/070863, filed on Aug. 1, 2018, the disclosure of which is hereby incorporated by reference in its entirety.

### TECHNICAL FIELD

Embodiments of the invention relate to the field of personal display devices. More specifically, embodiments of the invention relate to a retinal display apparatus and method.

### BACKGROUND

Personal display devices make it possible to provide image content to a viewer in applications where the use of conventional display screens would be an encumbrance. Head-mounted display (HMD) devices (also referred to as near-eye display (NED) or near-to-eye (NTE) devices), such as display goggles, are being considered as a useful type of wearable personal display device usable in a variety of fields, with applications ranging from military, medical, dental, industrial, and game presentation, among others.

It is known that Maxwellian HMDs (also referred to as retinal display devices) offer an accommodation-free display which allows a user to steadily observe both real and virtual objects, a key feature which cannot be provided by conventional HMDs. However, conventionally a Maxwellian view is limited by its extremely narrow field of view that requires the beam to strictly converge at the center of the crystalline lens. This narrow field of view is insufficient to provide a convenient user viewing experience and thus limiting the deployment of such technology.

Lin, J. et al., “Retinal projection head-mounted display,” in Journal of Frontiers of Optoelectronics, 10(1): 1-8, 2017 discloses a so-called modified Maxwellian view for expanding the field of view to a certain extent. However, the suggested approach neglects the crystalline accommodation, narrows the pupil aperture, and reduces the view angle field.

Thus, there is still a need for an improved retinal display apparatus and method providing a larger field of view for a user.

### SUMMARY

Embodiments of the invention are defined by the features of the independent claims, and further advantageous implementations of the embodiments by the features of the dependent claims.

According to a first aspect the invention relates to a retinal display apparatus for generating an image on the retina of an eye of a user, wherein the retinal display apparatus is configured to: generate an output beam conveying the image, i.e., an image beam, which may be composed of pixel beams; provide eye information, which comprises information about a current orientation, i.e., viewing direction of the eye; and steer the output beam based on the eye information to direct the output beam to the pupil of the eye.

Thus, an improved retinal display apparatus is provided. The apparatus allows moving the exit pupil location dynamically based on a tracked eye position and/or orientation. The user can thus move the eyes without losing the image on the retina.

As will be described in more detail below, in an embodiment, the retinal display apparatus comprises a movable dynamic aperture stop and an image displacement module which are synchronized with the exit pupil movement. In another embodiment, the retinal display apparatus comprises a light source emitting a set of collimated rays, i.e., a beam and a controllable reflective screen and/or light source to steer the angle of incidence of the rays. The exit pupil location can be estimated based on a tracked eye movement. In an embodiment, only one exit pupil is active at a time to avoid double image artifacts. In an embodiment, the tracked eye location can trigger the retinal display apparatus to either place the exit pupil in an arbitrary location or in a determined location among a given set of locations which represent an optimally sampled location of a possible eye movement.

More specifically, in a further possible implementation form of the first aspect, the retinal display apparatus comprises: a diffuse screen for displaying the image on a spatial portion of the screen and a beam shaper for generating the output beam from the displayed image. The beam shaper can comprise an aperture stop for defining an aperture, wherein the retinal display apparatus is configured to adjust the spatial portion of the screen and a position of the aperture on the basis of the eye information. Thus, allowing the output beam to be steered.

In a further possible implementation form of the first aspect, the retinal display apparatus is configured to adjust the position of the aperture on the basis of the eye information by displacing the aperture stop. The position of the aperture stop can thus be adjusted in a simple and reliable manner.

In a further possible implementation form of the first aspect, the aperture stop comprises a plurality of openings, wherein the retinal display apparatus is configured to mechanically open a selected one and to close the other ones of the plurality of openings on the basis of the eye information. The position of the aperture stop can thus be adjusted with no need for displacing the whole aperture stop.

In a further possible implementation form of the first aspect, the retinal display apparatus is configured to position the aperture at one of a plurality of discrete positions on the basis of the eye information.

In a further possible implementation form of the first aspect, the retinal display apparatus further comprises: a beam generator configured to generate an optical source beam representing the image; a reflective screen configured to reflect the optical source beam; and a beam shaper for generating the output beam from the reflected source beam, wherein the retinal display apparatus is configured to adjust an orientation of the beam generator on the basis of the eye information. Thus, the angle of incidence of the reflected source beam on the beam shaper, and thus the output beam, can be steered. In an embodiment, the beam shaper can comprise a lens assembly and, thus, does not require an aperture stop.

In a further possible implementation form of the first aspect, the retinal display apparatus comprises: a beam generator configured to generate an optical source beam representing the image; a reflective screen configured to reflect the optical source beam; and a beam shaper for generating the output beam from the reflected source beam, wherein the retinal display apparatus is configured to adjust an orientation of the reflective screen on the basis of the eye information. Thus, the angle of incidence of the reflected source beam on the beam shaper, and thus the output beam, can be steered. In an embodiment, the beam shaper can comprise a lens assembly and, thus, does not require an aperture stop.

In a further possible implementation form of the first aspect, the beam generator is configured to generate a plurality of pixel beams, wherein each of the pixel beams corresponds to a pixel of the image and the plurality of pixel beams compose the source beam. Each pixel beam may be a laser beam. This type of beam generator is described, for example, in Lin, J. et al., “Retinal projection head-mounted display,” in Journal of Frontiers of Optoelectronics, 10(1): 1-8, 2017.

According to a second aspect the invention relates to a near eye display apparatus comprising one or more retinal display apparatuses according to the first aspect of the invention.

According to a third aspect the invention relates to a corresponding retinal display method for generating an image on the retina of an eye of a user. The retinal display method comprises the steps of: generating an output beam conveying the image; providing eye information, which comprises information about an orientation of the eye; and steering the output beam based on the eye information to direct the output beam to the pupil of the eye.

The retinal display method according to the third aspect of the invention can be performed by the retinal display apparatus according to the first aspect of the invention. Further features of the retinal display method according to the third aspect of the invention result directly from the functionality of the retinal display apparatus according to the first aspect of the invention and its different implementation forms described above and below.

According to a fourth aspect the invention relates to a computer program product comprising program code for performing the method according to the third aspect when executed on a computer.

Details of one or more embodiments are set forth in the accompanying drawings and the description below. Other features, objects, and advantages will be apparent from the description, drawings, and claims.

### BRIEF DESCRIPTION OF THE DRAWINGS

The following embodiments of the invention are described with reference to the following figures, in which:

FIG. 1 is a schematic diagram showing an example of a retinal display apparatus according to an embodiment of the invention;

FIG. 2 is a schematic diagram showing an example of a retinal display apparatus according to an embodiment of the invention;

FIG. 3 is a schematic diagram showing an example of a retinal display apparatus according to an embodiment of the invention;

FIG. 4a is a schematic diagram showing an example of an aperture stop of a retinal display apparatus according to an embodiment of the invention;

FIG. 4b is a schematic diagram showing an example of an aperture stop of a retinal display apparatus according to an embodiment of the invention; and

FIG. 5 is a flow diagram showing an example of a retinal display method according to an embodiment of the invention.

In the following identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the invention or specific aspects in which embodiments of the invention may be used. It is understood that embodiments of the invention may be used in other aspects and comprise structural or logical changes not depicted in the figures. The following detailed description, therefore, is not to be taken in a limiting sense, and the scope of the invention is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g., functional units, to perform the described one or plurality of method steps (e.g., one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g., functional units, a corresponding method may include one step to perform the functionality of the one or plurality of units (e.g., one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

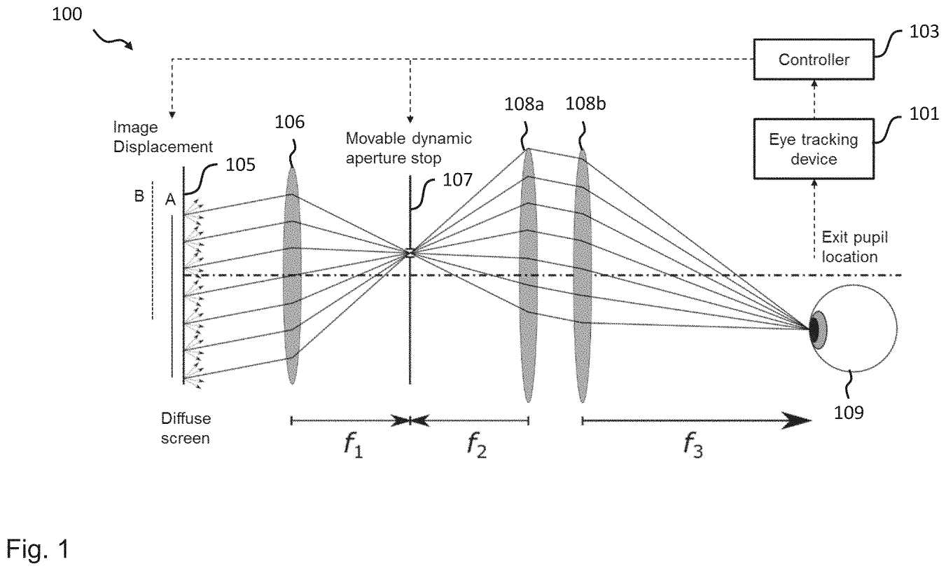

FIG. 1 shows a retinal display apparatus 100 according to an embodiment for generating an image on the retina of an eye 109 of a user. According to an embodiment, the retinal display apparatus 100 can be implemented in a near eye display apparatus, such as display goggles.

As will be described in more detail further below, the retinal display apparatus 100 is configured to: generate an output beam conveying the image, i.e. an image beam, which may be composed of pixel beams; provide eye information, which comprises information about a current orientation, i.e. current viewing direction of the eye 109; and steer the output beam based on the eye information to direct the output beam to the pupil of the eye 109.

To this end, the retinal display apparatus 100 shown in FIG. 1 comprises an eye tracking device 101, a controller 103, a diffuse screen 105 for displaying the image on a spatial portion of the diffuse screen 105, a movable dynamic aperture stop 107, a beam shaper in the form of an arrangement of lenses 106, 108a, 108b (having respective focal lengths f₁, f₂ and f₃) for generating the output beam from the displayed image on the diffuse screen and a beam generator in the form of a light engine (not shown in FIG. 1) for generating the initial optical source beam and exposing the diffuse screen thereto 105. As will be appreciated by the person skilled in the art, eye tracking is the process of measuring the point of gaze (where one is looking) and/or the motion of an eye relative to the head. Thus, as used herein, an eye tracker, such as the eye tracking device 101, is a device for measuring eye positions and/or eye movement.

In an embodiment, the light engine is configured to generate a single image collimated beam (a set of light rays). In an embodiment, the light engine can comprise a laser. In an embodiment, the light engine is configured to generate a plurality of pixel beams, wherein each of the pixel beams corresponds to a pixel of the image and the plurality of pixel beams compose the source beam. Each pixel beam may be a laser beam. This type of beam generator is described, for example, in Lin, J. et al., “Retinal projection head-mounted display”, in Journal of Frontiers of Optoelectronics, 10(1): 1-8, 2017, which is herein fully incorporated by reference.

In the exemplary embodiment shown in FIG. 1, based on the input from the eye tracking device 101, the controller 103 will receive the eye information, e.g., an estimated exit pupil location, which will then be used by the controller 103 to trigger movement of the movable dynamic aperture stop 107 and/or the image on the diffuse screen 105. As illustrated in FIG. 1, at the given exit pupil location, the user can see the region A of the diffuse screen 105 because firstly, the movable dynamic aperture stop 107 is ensuring that only those collimated rays from region A on the screen 105 are allowed to pass through to be directed towards the exit pupil location, and secondly, the displacement of the diffuse screen 105 is ensuring that the image content is shown on the exact region A of the diffuse screen 105. Assuming that another exit pupil location is chosen where this corresponds to the region B in FIG. 1, the displacement of the diffuse screen 105 is then showing the same exact image content to fit into the region B. This makes sure that the user is provided with the same image content regardless of the chose exit pupil location.

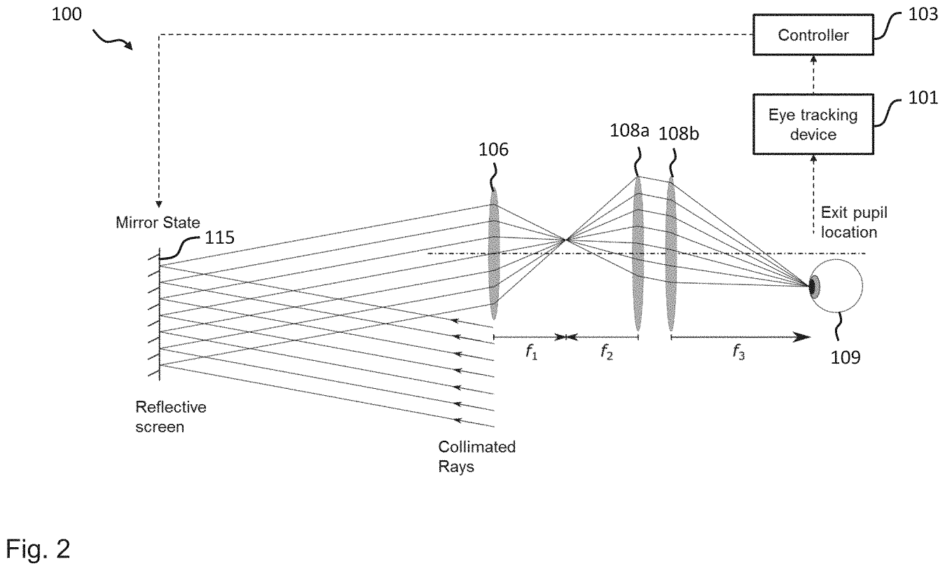

A further embodiment of the retinal display apparatus 100 is shown in FIG. 2 without the movable dynamic aperture stop 107 of the embodiment shown in FIG. 1. In this embodiment, the controller 103 is configured to steer (on the basis of the current orientation of the eye 109) a reflective screen 115 (i.e. a mirror as in e.g., Microelectromechanical systems (MEMS)), corresponding to the diffuse screen 105 of the embodiment shown in FIG. 1, to steer the angle of incidence of the output beam onto the beam shaper, i.e. the arrangement of lenses 106, 108a, 108b given a fixed position of the light engine.

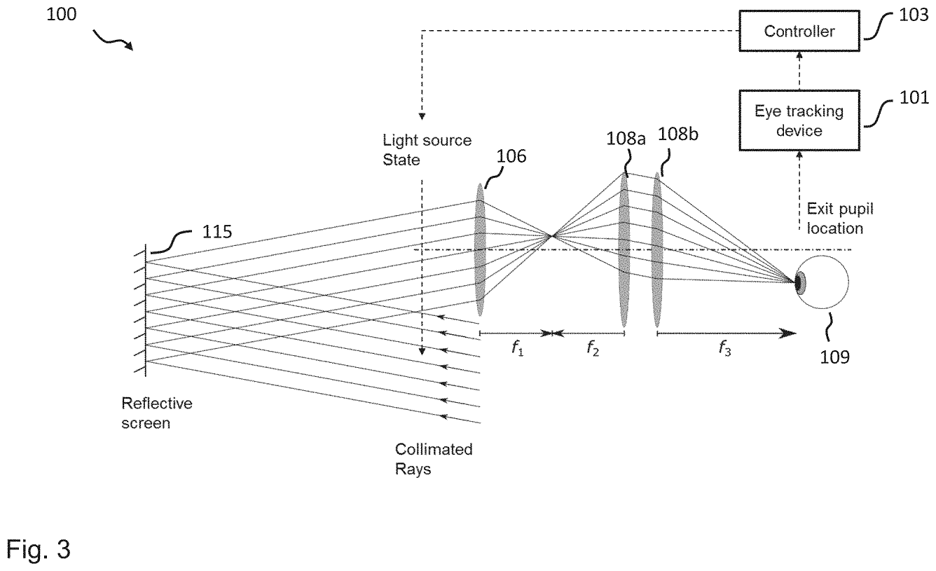

In a further embodiment of the retinal display apparatus 100 shown in FIG. 3 the controller 103 is configured to steer or adjust (on the basis of the current orientation of the eye 109) the orientation of the beam generator, i.e. light engine for steering the angle of incidence of the source beam onto the reflective screen 115. In a further embodiment, the controller 103 can be configured to adjust both the orientation of the light engine and the orientation/position of the reflective screen on the basis of the eye information for steering the angle of incidence of the output beam onto the beam shaper, i.e. the arrangement of lenses 106, 108a, 108b.

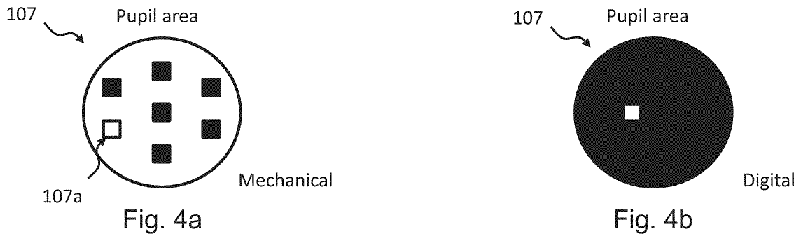

FIGS. 4a and 4b show different embodiments of the aperture stop 107 implemented in the retinal display apparatus 100 according to different embodiments, which can be based on a “mechanical approach” or a “digital approach.”

In the “mechanical approach” illustrated in FIG. 4a the aperture stop 107 comprises a set of sampled exit pupils, wherein the controller 103 is configured to activate one exit pupil location at a time based on the eye information provided by the eye tracker device 101 and, thereby, define the aperture 107a. This can be implemented by having a mechanical device having a set of holes representing the sampled exit pupils and allowing only one hole to be activated at a time.

In the “digital approach” illustrated in FIG. 4b the controller 103 can be configured to allow the light to pass through a small area corresponding to the tracked eye position and thereby define the aperture 107a. This can be achieved using, for instance, Maxwellian view retinal projectors, as disclosed in Lin, J. et al., “Retinal projection head-mounted display,” in Journal of Frontiers of Optoelectronics, 10(1): 1-8, 2017, which is herein fully incorporated by reference, or Pinlight arrays, as disclosed in Maimone, A. et al: “Pinlight Displays: Wide Field of View Augmented Reality Eyeglasses Using Defocused Point Light Sources,” SIGGRAPH 2014 (Vancouver, Canada, Aug. 10-14, 2014), which is herein fully incorporated by reference. As will be appreciated, the digital approach allows to provide for a continuously movable aperture 107a, where the exit pupil can occupy an arbitrary position in the given area, or, alternatively, in a discrete manner where the next location in the movement is only possible with a certain allowed distance (similar concept as the mechanical approach). Moreover, as will be appreciated, the aperture stops 107 illustrated in FIGS. 4a and 4b can provide and/or replace the movable aperture stop 107 of the retinal display apparatus 100 of FIG. 1. As already described above, in the embodiments of the retinal display apparatus shown in FIGS. 2 and 3 the aperture stop 107 is not necessary, but can be implemented as well.

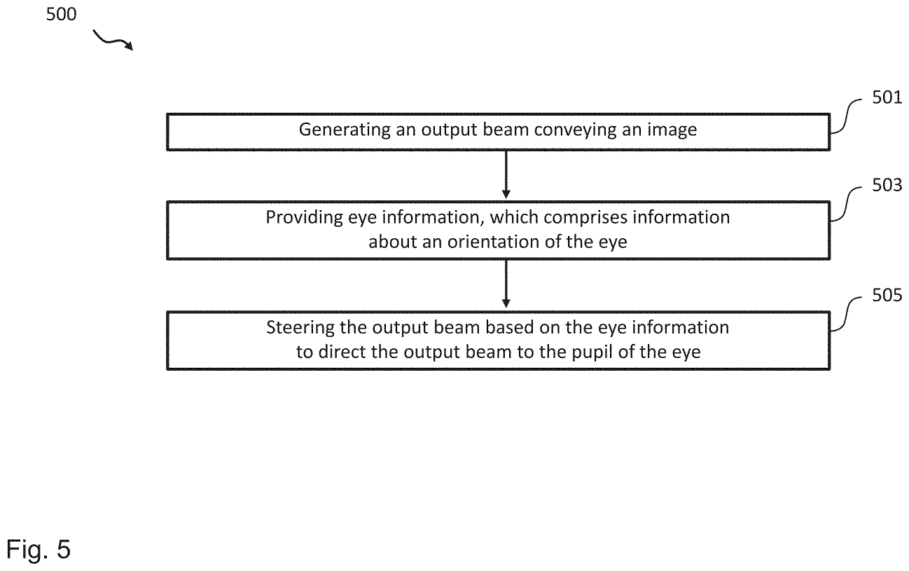

FIG. 5 is a flow diagram showing an example of a corresponding retinal display method 500 according to an embodiment of the invention. The retinal display method 500 comprises the following steps: generating 501 the output beam conveying the image; providing 503 the eye information, which comprises information about the current orientation of the eye 109; and steering 505 the output beam based on the eye information to direct the output beam to the pupil of the eye 109. Further embodiments of the retinal display method 500 are based on the above embodiments of the corresponding retinal display apparatus 100.

The person skilled in the art will understand that the “blocks” (“units”) of the various figures (method and apparatus) represent or describe functionalities of embodiments of the invention (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the invention may be integrated into one processing unit, or each of the units may exist alone physically, or two or more units are integrated into one unit.

What is claimed is:

1. A retinal display apparatus for generating an image on a retina of an eye of a user, wherein the retinal display apparatus is configured to:
generate an output beam conveying the image;
provide eye information, which comprises information about an orientation of the eye; and
steer the output beam based on the eye information to direct the output beam to a pupil of the eye.

2. The retinal display apparatus of claim 1, wherein the retinal display apparatus comprises:
a screen for displaying the image on a spatial portion of the screen; and
a beam shaper for generating the output beam from the displayed image, wherein the beam shaper comprises an aperture stop defining an aperture, and wherein the retinal display apparatus is configured to adjust the spatial portion of the screen and a position of the aperture based on the eye information.

3. The retinal display apparatus of claim 2, wherein the retinal display apparatus is configured to adjust the position of the aperture based on the eye information by displacing the aperture stop.

4. The retinal display apparatus of claim 2, wherein the aperture stop comprises a plurality of openings, wherein the retinal display apparatus is configured to open a selected opening of the plurality of openings and to close non-selected openings of the of the plurality of openings based on the eye information.

5. The retinal display apparatus of claim 2, wherein the retinal display apparatus is configured to position the aperture at one of a plurality of discrete positions based on the eye information.

6. The retinal display apparatus of claim 1, wherein the retinal display apparatus comprises:
a beam generator configured to generate a source beam representing the image;
a reflective screen configured to reflect the source beam; and
a beam shaper for generating the output beam from the reflected source beam,
wherein the retinal display apparatus is configured to adjust an orientation of the beam generator based on the eye information.

7. The retinal display apparatus of claim 1, wherein the retinal display apparatus comprises:
a beam generator configured to generate a source beam representing the image;
a reflective screen configured to reflect the source beam; and
a beam shaper for generating the output beam from the reflected source beam,
wherein the retinal display apparatus is configured to adjust an orientation of the reflective screen based on the eye information.

8. The retinal display apparatus of claim 6, wherein the beam generator is configured to generate a plurality of pixel beams, wherein each of the pixel beams corresponds to a pixel of the image and wherein the plurality of pixel beams compose the source beam.

9. The retinal display apparatus of claim 7, wherein the beam generator is configured to generate a plurality of pixel beams, wherein each of the pixel beams corresponds to a pixel of the image and wherein the plurality of pixel beams compose the source beam.

10. A near eye display apparatus comprising one or more retinal display apparatuses, wherein each retinal display apparatus of the one or more retinal display apparatuses are for generating an image on a retina of an eye of a user and are configured to:
generate an output beam conveying the image;
provide eye information, which comprises information about an orientation of the eye; and
steer the output beam based on the eye information to direct the output beam to a pupil of the eye.

11. The near eye display apparatus of claim 10, wherein each retinal display apparatus of the one or more retinal display apparatuses comprises:
a screen for displaying the image on a spatial portion of the screen; and
a beam shaper for generating the output beam from the displayed image, wherein the beam shaper comprises an aperture stop defining an aperture, and wherein the retinal display apparatus is configured to adjust the spatial portion of the screen and a position of the aperture based on the eye information.

12. The near eye display apparatus of claim 11, wherein each retinal display apparatus of the one or more retinal display apparatuses is configured to adjust the position of the aperture based on the eye information by displacing the aperture stop.

13. The near eye display apparatus of claim 11, wherein the aperture stop comprises a plurality of openings, wherein the retinal display apparatus is configured to open a selected opening of the plurality of openings and to close non-selected openings of the of the plurality of openings based on the eye information.

14. The near eye display apparatus of claim 11, wherein each retinal display apparatus of the one or more retinal display apparatuses is configured to position the aperture at one of a plurality of discrete positions based on the eye information.

15. The near eye display apparatus of claim 10, wherein each retinal display apparatus of the one or more retinal display apparatuses comprises:
a beam generator configured to generate a source beam representing the image;
a reflective screen configured to reflect the source beam; and
a beam shaper for generating the output beam from the reflected source beam,
wherein each retinal display apparatus of the one or more retinal display apparatuses is configured to adjust an orientation of the beam generator based on the eye information.

16. The near eye display apparatus of claim 10, wherein each retinal display apparatus of the one or more retinal display apparatuses comprises:
a beam generator configured to generate a source beam representing the image;
a reflective screen configured to reflect the source beam; and
a beam shaper for generating the output beam from the reflected source beam,
wherein each retinal display apparatus of the one or more retinal display apparatuses is configured to adjust an orientation of the reflective screen based on the eye information.

17. The near eye display apparatus of claim 16, wherein the beam generator is configured to generate a plurality of pixel beams, wherein each of the pixel beams corresponds to a pixel of the image and wherein the plurality of pixel beams compose the source beam.

18. The near eye display apparatus of claim 17, wherein the beam generator is configured to generate a plurality of pixel beams, wherein each of the pixel beams corresponds to a pixel of the image and wherein the plurality of pixel beams compose the source beam.

19. A retinal display method for generating an image on a retina of an eye of a user, wherein the retinal display method comprises:
generating an output beam conveying the image;
providing eye information, which comprises information about an orientation of the eye; and
steering the output beam based on the eye information to direct the output beam to the pupil of the eye.
